(19) United States
(12) Patent Application Publication
(10) Pub. No.: US 2011/0277983 A1
(43) Pub. Date: Nov. 17, 2011

(54) TEMPERATURE CONTROLLER, FLUID CIRCULATOR AND TEMPERATURE CONTROL METHOD USING TEMPERATURE CONTROLLER

(75) Inventor: Norio TAKAHASHI, Hiratsuka-shi (JP)

(73) Assignee: KELK LTD., Hiratsuka-shi (JP)

(21) Appl. No.: 13/106,020

(22) Filed: May 12, 2011

(30) Foreign Application Priority Data
May 13, 2010 (JP) 2010-110913

(51) Int. Cl. F28F 27/00; F15D 1/00; F28D 15/00

(52) U.S. Cl. 165/300; 165/104.11; 137/334

(57) ABSTRACT

A temperature controller includes: a closed first circulation circuit having a fluid cooler; a closed second circulation circuit having a halogen lamp heater as a fluid heater and feeding a thermal fluid heated by the halogen lamp heater to a vacuum chamber as an object to be temperature-controlled; a feed path that feeds the thermal fluid from the first circulation circuit to the second circulation circuit; and a discharge path that discharges the thermal fluid from the second circulation circuit and returns the thermal fluid to the first circulation circuit. A flow-rate control valve that adjusts and controls a feed flow-rate of the thermal fluid from the first circulation circuit is provided in the feed path. A pressure control valve that compensates a pressure of the thermal fluid at a predetermined pressure level or less is provided in the discharge path.

The entire disclosure of Japanese Patent Application No. 2010-110913 filed May 13, 2010 is expressly incorporated by reference herein.

### BACKGROUND OF THE INVENTION

1. Field of the Invention

The present invention relates to a temperature controller for controlling a temperature of an object to be temperature-controlled, a fluid circulator for circulating and feeding a thermal fluid adjusted to a predetermined temperature to the object, and a temperature control method using the temperature controller.

2. Description of Related Art

Typically, a semiconductor wafer is subjected to various semiconductor treatment such as plasma etching treatment using plasma heat. Such various semiconductor treatment are generally performed by circulating and feeding a thermal fluid adjusted to a predetermined target temperature to an object to be temperature-controlled such as a vacuum chamber, and controlling a temperature of the object by means of the circulated and fed thermal fluid. A temperature controller for performing such a temperature control has been known (for instance, see Document 1: JP-A-11-282545).

The temperature controller includes a fluid circulator as a main circulation circuit of the thermal fluid. The main circulation circuit is provided with a fluid heater for heating the thermal fluid and a cooling circuit for cooling the thermal fluid is connected to the main circulation circuit. In the main circulation circuit, a plurality of flow-rate control valves for adjusting and controlling a passing flow-rate of the thermal fluid are disposed.

The temperature controller also includes a pressure absorber such as bellows tube capable of easily changing a volume thereof in accordance with variation in inner pressure thereof in order to absorb pressure variation generated in the main circulation circuit.

In the temperature controller, temperature control of the thermal fluid is performed by controlling output of the fluid heater while keeping all flow-rate control valves at a predetermined valve opening degree.

However, in a typical temperature controller and fluid circulator as described in Document 1, since the flow-rate control valves are provided in the main circulation circuit, a large-sized flow-rate control valve capable of controlling a large flow rate is required. Moreover, a typical pressure absorber becomes large in structure. Accordingly, the temperature controller and the fluid circulator become large in their entirety.

Further, since a plurality of flow-rate control valves are disposed, manufacturing costs of the temperature controller and the fluid circulator become expensive.

Additionally, in a typical temperature control method as described in Document 1, since a plurality of flow-rate control valves are used, pressure variation of the fluid becomes large and a temperature and a flow rate of the fluid become unstable when controlling flow rates from a large flow rate to a small flow rate. In such a case, it is difficult or it takes times to control the flow rates in a broad range. Accordingly, a range of the flow rates to be controlled needs to be narrowed. Thus, output from the fluid heater becomes large and an amount of consumption energy in controlling a temperature becomes large.

### SUMMARY OF THE INVENTION

An object of the invention is to provide a temperature controller and a fluid circulator that are compactible in their entirety and reducible in manufacturing costs. Another object of the invention is to provide a temperature control method for temperature control with energy saving by using the above temperature controller.

According to an aspect of the invention, a temperature controller, which circulates and feeds a thermal fluid adjusted to a predetermined target temperature to an object to be temperature-controlled and controls a temperature of the object by means of the circulated and fed thermal fluid, includes: a closed first circulation circuit having a fluid cooler; a closed second circulation circuit having a fluid heater and feeding a thermal fluid heated by the fluid heater to the object; a feed path that feeds the thermal fluid from the first circulation circuit to the second circulation circuit; and a discharge path that discharges the thermal fluid from the second circulation circuit and returns the thermal fluid to the first circulation circuit, in which a flow-rate control valve that adjusts and controls a feed flow-rate of the thermal fluid from the first circulation circuit is provided in the feed path, and a pressure control valve that compensates a pressure of the thermal fluid at a predetermined pressure level or less is provided in the discharge path.

According to the temperature controller in the aspect of the invention, the flow-rate control valve is provided in the feed path between the first circulation circuit (a main circulation circuit) and the second circulation circuit, not provided in either the first circulation circuit or the second first circulation circuit. Accordingly, the flow-rate control valve is not required to be capable of controlling a large flow rate. Consequently, the flow-rate control valve can be down-sized since a large-sized flow-rate control valve is unnecessary.

The pressure control valve, which operates when a pressure in the second circulation circuit becomes a predetermined pressure level or more by the thermal fluids being mixed, is provided in the discharge path. The pressure control valve also prevents pressure variation in the second circulation circuit which is attributed to expansion and shrinkage of the thermal fluid. A typical large-sized pressure controller using a pressure absorber such as bellows tube becomes unnecessary, so that a pressure adjuster of the thermal fluid can be down-sized. Accordingly, an entirety of the temperature controller is compactible.

Since only one flow-rate control valve is sufficient, manufacturing costs can be reduced as compared with a case where a plurality of flow-rate control valves are provided.

In the temperature controller according to the above aspect of the invention, a temperature sensor that detects a temperature of the thermal fluid returned from the object is provided in the vicinity of a flow outlet through which the thermal fluid is discharged from the object.

With this arrangement, since the temperature sensor is provided in the vicinity of the flow outlet through which the thermal fluid is discharged from the object, the temperature sensor can measure and detect a temperature of the thermal fluid just after passing through and being returned from the object, so that it can be accurately checked whether the temperature of the thermal fluid is at the target temperature or not.

A fluid circulator according to another aspect of the invention includes: a closed circulation circuit having a fluid heater and feeding a thermal fluid heated by the fluid heater to an object to be temperature-controlled; a feed path that feeds a cooled thermal fluid to the circulation circuit; and a discharge path that discharges the thermal fluid fed from the circulation circuit, in which a flow-rate control valve that adjusts and controls a feed flow-rate of the cooled thermal fluid is provided in the feed path, and a pressure control valve that compensates a pressure of the thermal fluid in the circulation circuit at a predetermined pressure level or less is provided in the discharge path.

With this arrangement, the same advantages as those of the above temperature controller can be obtained.

In the fluid circulator according to the above aspect of the invention, a temperature sensor that detects a temperature of the thermal fluid returned from the object is provided in the vicinity of a flow outlet through which the thermal fluid is discharged from the object.

With this arrangement, the same advantages as those of the above temperature controller can be obtained.

According to still another aspect of the invention, a temperature control method using the temperature controller according to the above aspect of the invention for controlling a temperature of the object by means of the thermal fluid circulated and fed by the temperature controller includes: detecting a temperature of the thermal fluid returned from the object and calculating a temperature difference between the detected temperature and a target temperature of the thermal fluid fed to the object; adjusting and controlling a valve opening degree of the flow-rate control valve based on the calculated result; after adjusting and controlling the valve opening degree of the flow-rate control valve, detecting a temperature of the thermal fluid fed to the object through the fluid heater and calculating a temperature difference between the detected temperature and the target temperature; and controlling an output of the fluid heater based on the calculated result.

According to the temperature control method in the above aspect of the invention, the temperature of the thermal fluid can also be adjusted and controlled by adjusting and controlling the valve opening degree of the flow-rate control valve before controlling the output of the fluid heater. Accordingly, as compared with a case where the temperature of the thermal fluid is controlled only by controlling the output of the fluid heater, the output of the fluid heater is particularly reduced, thereby achieving temperature control with less energy.

According to the temperature controller and the fluid circulator with these arrangements, since the flow-rate control valve is not provided in either the first circulation circuit (the main circulation circuit) or the second circulation circuit, a large-sized flow-rate control valve becomes unnecessary and the flow-rate control valve can be down-sized. Moreover, the pressure control valve provided in the discharge path prevents pressure variation in the second circulation circuit. Accordingly, a typical large-sized pressure controller becomes unnecessary and a pressure adjuster of the thermal fluid can be down-sized. Accordingly, the temperature controller and the fluid circulator can be compactible in their entirety.

Further, since only one flow-rate control valve is sufficient, manufacturing costs of the temperature controller and the fluid circulator are reducible.

### BRIEF DESCRIPTION OF THE DRAWINGS

FIG. 1 is a circuit diagram showing a temperature controller and a fluid circulator according to an exemplary embodiment of the invention.

FIG. 2 is a flow chart showing a temperature control method by the temperature controller of FIG. 1.

FIG. 3A is a time chart showing variation in amounts of heat to be output in a typical temperature control method.

FIG. 3B is a time chart showing variation in amounts of heat to be output in the temperature control method using the temperature controller according to the exemplary embodiment of the invention.

### DETAILED DESCRIPTION OF PREFERRED EMBODIMENT(S)

Exemplary embodiment(s) of the invention will be described below with reference to the attached drawings.

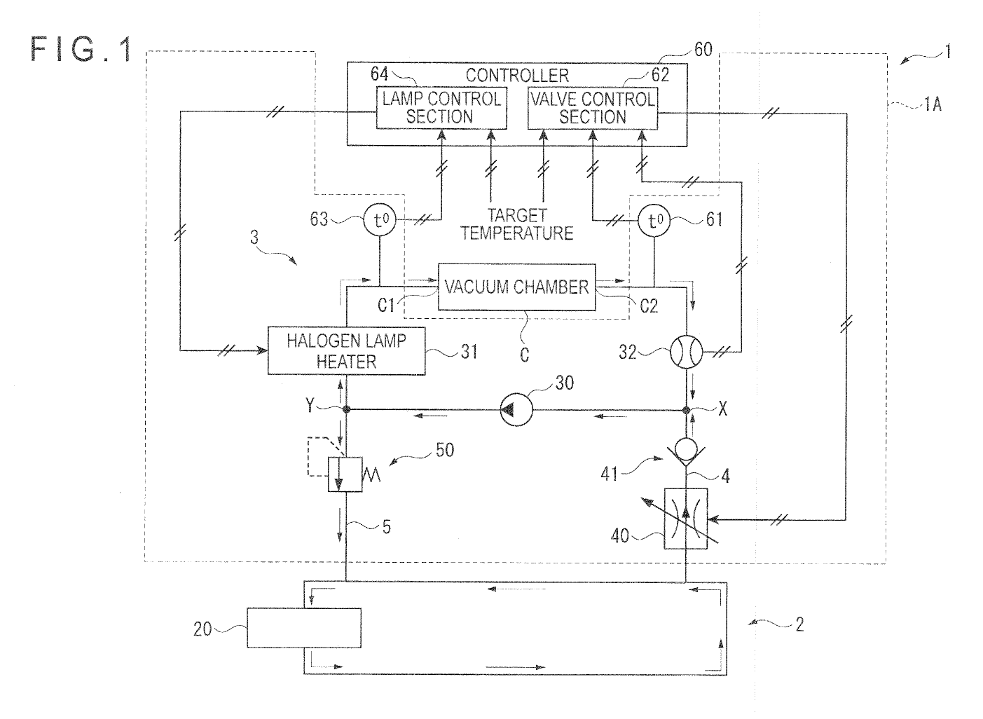

As shown in FIG. 1, a temperature controller 1 includes: a closed first circulation circuit 2; a closed second circulation circuit 3; a feed path 4 that feeds a thermal fluid from the first circulation circuit 2 to the second circulation circuit 3; a discharge path 5 that discharges the thermal fluid from the second circulation circuit 3 and returns the thermal fluid to the first circulation circuit 2; and a controller 60 provided with a valve control section 62 and a lamp control section 64. The temperature controller 1 circulates and feeds the thermal fluid adjusted to a predetermined target temperature Sᵥ to a vacuum chamber C (an object to be temperature-controlled) and controls a temperature of the vacuum chamber C by means of the circulated and fed thermal fluid.

As shown in FIG. 1 in a dotted line, the second circulation circuit 3, the feed path 4 and the discharge path 5 provides a fluid circulator 1A.

The vacuum chamber C includes a susceptor on which a semiconductor wafer is mounted. In the vacuum chamber C, the semiconductor wafer mounted on the susceptor is subjected to various semiconductor treatments such as plasma etching. The vacuum chamber C includes: a flow inlet C1 in which the thermal fluid is fed; and a flow outlet C2 from which the thermal fluid is discharged. The thermal fluid fed through the flow inlet C1 is fed to the susceptor. Thus, by means of the circulated and fed thermal fluid, a temperature of the vacuum chamber C, specifically, a temperature of the susceptor is controlled. Moreover, by means of the circulated and fed thermal fluid, the semiconductor wafer in the vacuum chamber C is kept by the susceptor at a temperature in accordance with the treatments.

The thermal fluid can be suitably selected from liquids such as FLUORINART (registered trademark), ethylene glycol, oil and water, and gas such as nitrogen, air and helium in accordance with kinds of semiconductor treatments and a target temperature Sᵥ.

The first circulation circuit 2 includes a chiller 20 and the like, which provides a closed circulation circuit of a thermal fluid. In FIG. 1, components other than the chiller 20 are omitted. The chiller 20 includes an evaporator as a fluid cooler (not shown) and the like. The thermal fluid is cooled in the evaporator. A temperature of the thermal fluid circulating in the first circulation circuit 2 is approximately 90 degrees C. in this exemplary embodiment.

The second circulation circuit 3 is a closed circulation circuit in which the thermal fluid is circulated in a sequential order of a feed pump 30, a halogen lamp heater 31 (a fluid heater), the vacuum chamber C, a flow-rate sensor 32, and the feed pump 30. A temperature of the thermal fluid circulating in the second circulation circuit 3 is approximately 150 degrees C. in the exemplary embodiment.

The feed pump 30 circulates and feeds the thermal fluid to the vacuum chamber C. The thermal fluid at this time is a mixture at a junction X of the thermal fluid returned from the flow outlet C2 of the vacuum chamber C and a portion of the thermal fluid cooled in the first circulation circuit 2.

The halogen lamp heater 31 is photothermic one provided with a halogen lamp (not shown). In the mixture of the thermal fluid at the junction X, the thermal fluid separated at a branch portion Y toward the vacuum chamber C is fed to the halogen lamp heater 31. The thermal fluid fed to the halogen lamp heater 31 absorbs infrared radiation irradiated from the lighting halogen lamp and is heated by radiant heat of the infrared radiation. The thermal fluid heated by the halogen lamp heater 31 is fed to the vacuum chamber C.

The flow-rate sensor 32 measures and detects a passing flow rate of the thermal fluid returned from the flow outlet C2 of the vacuum chamber C to the second circulation circuit 3.

A flow-rate control valve 40 and a check valve 41 are provided in the feed path 4. The flow-rate control valve 40 adjusts the passing flow rate of the thermal fluid cooled in the first circulation circuit 2 to the second circulation circuit 3 by an opening degree of the flow-rate control valve 40 being adjusted and controlled.

The check valve 41 prevents the thermal fluid having passed through the flow-rate control valve 40 from flowing back to the first circulation circuit 2.

A pressure control valve 50 is provided in the discharge path 5. After the thermal fluid is mixed at the junction X, a pressure of the thermal fluid in the second circulation circuit 3 increases. When the pressure of the thermal fluid in the second circulation circuit 3 increases and becomes a predetermined pressure level or more, the pressure control valve 50 is opened and keeps the pressure in the second circulation circuit 3 at a predetermined level by discharging a portion of the thermal fluid toward the first circulation circuit 2 via the branch portion Y. Pressure variation in the second circulation circuit 3 is attributed to expansion or shrinkage of the thermal fluid caused by temperature change. The pressure control valve 50 also prevents such pressure variation. In other words, the pressure control valve 50 compensates the pressure of the thermal fluid in the second circulation circuit 3 at a predetermined pressure level or less.

In the second circulation circuit 3 between the vacuum chamber C and the flow-rate sensor 32, an inlet-side temperature sensor 61 is provided in the vicinity of an inlet where the thermal fluid discharged from the vacuum chamber C flows into the second circulation circuit 3. The vicinity of the inlet means the vicinity of the flow outlet C2 of the vacuum chamber C.

The inlet-side temperature sensor 61 measures and detects an inlet temperature Pᵥ2 of the thermal fluid returned from the flow outlet C2 of the vacuum chamber C and outputs a temperature detection signal to the valve control section 62 of the controller 60.

In the controller 60, the valve control section 62 adjusts and controls the valve opening degree of the flow-rate control valve 40 based on a temperature difference T1 (=Sᵥ−Pᵥ2) between the inlet temperature Pᵥ2 and the predetermined target temperature Sᵥ, thereby adjusting the flow rate of the thermal fluid to be fed from the first circulation circuit 2 to the second circulation circuit 3 via the feed path 4.

In the second circulation circuit 3 between the halogen lamp heater 31 and the vacuum chamber C, an outlet-side temperature sensor 63 is provided in the vicinity of an outlet where the thermal fluid flows out from the second circulation circuit 3 towards the vacuum chamber C.

The outlet-side temperature sensor 63 measures and detects an outlet temperature Pᵥ1 of the thermal fluid having passed through the halogen lamp heater 31 and outputs a temperature detection signal to the lamp controller 64. The lamp controller 64 suitably adjusts a duty ratio of a lighting time and a lighting amount of the halogen lamp based on the temperature difference T2 (=Sᵥ−Pᵥ1) between the outlet temperature Pᵥ1 and the predetermined target temperature Sᵥ, and controls output of the halogen lamp heater 31.

In the temperature controller 1, after the valve opening degree of the flow-rate control valve 40 is set, the thermal fluid fed in accordance with the valve opening degree of the flow-rate control valve 40 and the thermal fluid returned from the vacuum chamber C are mixed at the junction X. The mixed fluid passes through the halogen lamp heater 31 via the branch portion Y and is fed to the vacuum chamber C. When the pressure of the mixed fluid reaches a predetermined pressure of the pressure control valve 50 in the second circulation circuit 3, a part of the mixed fluid is separated at the branch portion Y and is returned to the first circulation circuit 2 through the discharge path 5, and the remaining part of the mixed fluid passes through the halogen lamp heater 31 and is fed to the vacuum chamber C.

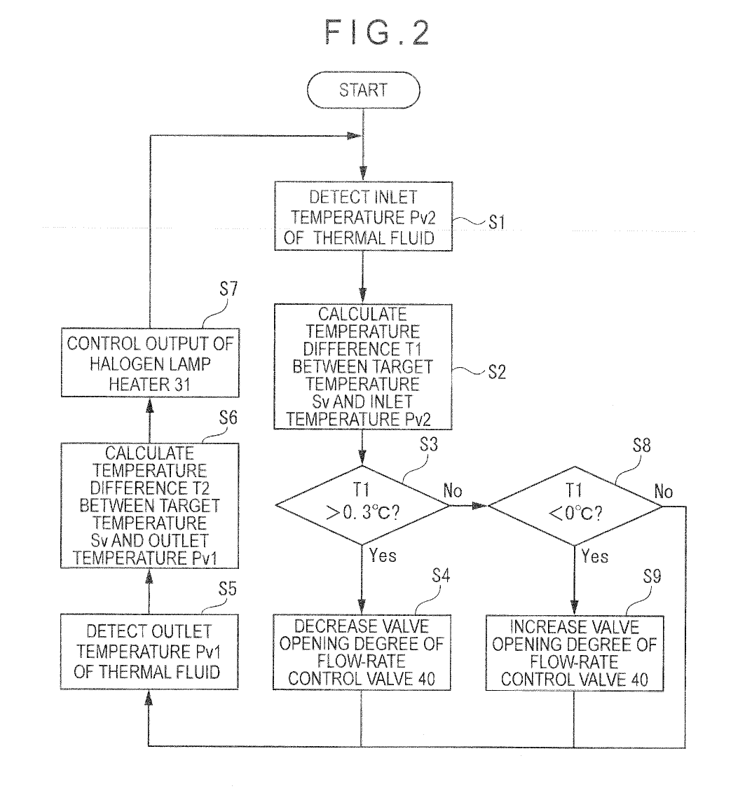

Next, a temperature control method by using the above temperature controller 1 when a semiconductor wafer is treated in the vacuum chamber C by a plasma etching treatment with use of plasma heat will be explained with reference to FIG. 2.

In the temperature control method, the valve opening degree of the flow-rate control valve 40 is determined, adjusted and controlled based on the temperature difference T1, and the output of the halogen lamp heater 31 is controlled based on the temperature difference T2, whereby the thermal fluid circulated and fed to the vacuum chamber C is controlled at a predetermined target temperature Sᵥ. Operational steps are shown as S1, S2 and the like as follows.

In S1, initially, the inlet-side temperature sensor 61 measures and detects the inlet temperature Pᵥ2 of the thermal fluid, and outputs a temperature detection signal to the valve control section 62. Next, in S2, the valve control section 62 calculates the temperature difference T1 between the target temperature Sᵥ and the inlet temperature Pᵥ2. In S3, the valve control section 62 judges whether the temperature difference T1 is larger than 0.3 degree C. or not.

When the temperature difference T1 is judged to be larger than 0.3 degree C. in S3, the operation proceeds to S4. The valve control section 62 decreases the valve opening degree of the flow-rate control valve 40 to a specified opening degree, thereby decreasing a passing flow rate of the thermal fluid cooled by the first circulation circuit 2 through the feed path 4. Although more elaborate feedback control is practically conducted, but a detailed explanation thereof will be omitted. The case where the temperature difference T1 is judged to be larger than 0.3 degree C. is exemplified by a case where plasma heat is not applied on a semiconductor wafer.

After the valve opening degree of the flow-rate control valve 40 is set, the thermal fluid provided by mixing the thermal fluid returned from the flow outlet C2 of the vacuum chamber C and a part of the thermal fluid cooled in the first circulation circuit 2 at the junction X is fed to the halogen lamp heater 31 by the feed pump 30 via the branch portion Y.

Then, in S5, the outlet-side temperature sensor 63 measures and detects the outlet temperature Pᵥ1 of the thermal fluid having passed through the halogen lamp heater 31 and outputs a temperature detection signal to the lamp controller 64. In S6, the lamp control section 64 calculates the temperature difference T2 between the target temperature Sᵥ and the outlet temperature Pᵥ. In S7, based on the calculated result, the lamp control section 64 controls the output of the halogen lamp heater 31 to bring the temperature of the thermal fluid fed to the vacuum chamber C close to the target temperature Sᵥ. In S7, for instance, when the outlet temperature Pᵥ1 is lower than the target temperature Sᵥ, the lighting amount of the halogen lamp heater 31 is increased to increase heat given to the thermal fluid, so that the temperature of the thermal fluid is brought close to the target temperature Sᵥ. In contrast, when the outlet temperature Pᵥ1 is higher than the target temperature Sᵥ, the lighting amount of the halogen lamp heater 31 is decreased to decrease heat given to the thermal fluid, so that the temperature of the thermal fluid is brought close to the target temperature Sᵥ.

On the other hand, when the temperature difference T1 is judged to be 0.3 degree C. or less in S3, the operation proceeds to S8, where the valve control section 62 judges whether the temperature difference T1 is smaller than 0 degree C. or not. The case where the temperature difference T1 is judged to be 0.3 degree C. or less is exemplified by a case where plasma heat is applied on a semiconductor wafer.

In S8, when the temperature difference T1 is judged to be smaller than 0 degree C., the inlet temperature Pᵥ2 is higher than the target temperature Sᵥ. Accordingly, the operation proceeds to S9, where the valve control section 62 increases the valve opening degree of the flow-rate control valve 40 to a specified opening degree, thereby increasing the passing flow rate of the thermal fluid cooled by the first circulation circuit 2 through the feed path 4. Subsequently, S5 to S7 are operated in the same manner as the operation via S4.

In S8, when the temperature difference T1 is judged to be 0 degree C. or more, the temperature difference T1 is from 0 degree C. to 0.3 degree C. At this time, the valve opening degree of the flow-rate control valve 40 is kept as it is and the operation proceeds to S5 to S7.

In S4 or S9, the valve opening degree of the flow-rate control valve 40 may not be a specified opening degree, but may be a predetermined opening degree in accordance with the temperature difference T1.

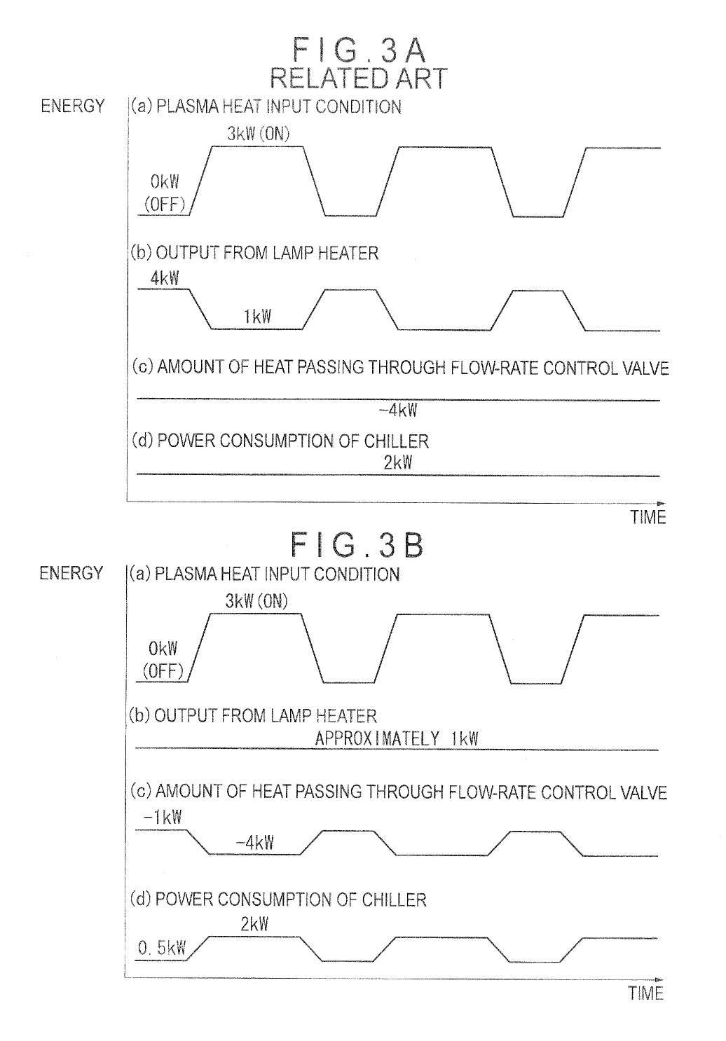

Next, advantages of the temperature control method by using the temperature controller 1 according to this exemplary embodiment will be explained with reference to FIGS. 3A and 3B.

As shown in FIG. 3A, in a typical temperature control method as described in Document 1, a valve opening degree of a flow-rate control valve is set at a predetermined level. As shown in FIG. 3A (c), an amount of heat passing through the flow-rate control valve 40 becomes −4 kW (a cooling amount of 4 kW). When a cooling efficiency COP (cooling heat relative to consumption heat) is defined as 2, consumption power to be consumed at the chiller 20 for maintaining the valve opening degree of the flow-rate control valve needs to be substantially constant, i.e., approximately 2 kW as shown in FIG. 3A (d).

When a semiconductor wafer is not treated by plasma heat (OFF condition in FIG. 3A (a)), the output of the lamp heater needs to be 4 kW to heat the thermal fluid in order to bring the thermal fluid to the target temperature as shown in FIG. 3A (b). Accordingly, total energy required for bringing the thermal fluid to the target temperature, specifically, combined energy of consumption power to be consumed at the chiller 20 and power to be used for the output of the lamp heater becomes 6 kW.

In contrast, as shown in FIG. 3B, in the temperature control method by using the temperature controller 1 according to the exemplary embodiment, the output of the halogen lamp heater 31 can be kept at substantially the same level. As shown in FIG. 3B (b), power to be used for the output needs to be substantially constant, i.e., approximately 1 kW.

In the temperature control method by using the temperature controller 1 according to the exemplary embodiment, before controlling the output of the halogen lamp heater 31 in S7 of FIG. 2, the temperature of the thermal fluid is also adjusted and controlled by adjusting and controlling the valve opening degree of the flow-rate control valve 40 as shown in S4 or S9. Accordingly, with the semiconductor wafer being not treated by plasma heat (OFF condition in FIG. 3B (a)), when the valve opening degree of the flow-rate control valve 40 is defined so that the thermal fluid reaches the target temperature Sᵥ, an amount of heat passing through the flow-rate control valve 40 becomes −1.0 kW (a cooling amount of 1.0 kW). At this time, as shown in FIG. 3B (d), when the cooling efficiency COP is defined as 2, the consumption power to be consumed at the chiller 20 becomes 0.5 kW. Accordingly, total energy required for bringing the thermal fluid to the target temperature Sᵥ becomes 1.5 kW, which is smaller than 6 kW of the total energy in the typical temperature control method as described in Document 1.

On the other hand, with a semiconductor being treated by 3 kW of plasma heat (ON condition in FIG. 3A(a) or 3B(a), in the typical temperature control method as described in Document 1, the total energy required for bringing the thermal fluid to the target temperature is 3 kW provided by 1 kW of power to be used for the output of the lamp heater and 2 kW of consumption power to be consumed at the chiller 20, as shown in 3A. In contrast, in the temperature control method using the temperature controller 1 according to the exemplary embodiment, as shown in FIG. 3B, total energy required for bringing the thermal fluid to the target temperature becomes 3 kW provided by 1 kW of power to be used for the output of the lamp heater 31 and 2 kW of consumption power to be consumed at the chiller 20, which is the same as the total energy of 3 kW in the typical temperature control method as described in Document 1. At this time, as shown in FIG. 3B (c), heat passing through the flow-rate control valve 40 is −4 kW (a cooling amount of 4 kW).

Thus, in the plasma etching treatment, during all steps with/without plasma heat treatment, the output total energy in the temperature control method using the temperature controller 1 according to the exemplary embodiment is smaller that that in the typical temperature control method as described in Document 1. Accordingly, temperature control can be conducted with less energy. Moreover, by keeping the output of the halogen lamp heater 31 at a small and predetermined level, down-sizing of the halogen lamp heater 31 and improvement in durability thereof can be achieved.

Note that the present invention is not limited to the embodiments as described above but may include various modifications, improvement and the like thereof as long as an object of the present invention can be achieved.

In the above exemplary embodiment, as the object to be temperature-controlled, the vacuum chamber C to be used for various semiconductor treatments on a semiconductor wafer is described. However, the temperature controller 1 and the fluid circulator 1A are also applicable to a treatment chamber and other constant temperature chambers used for applying various treatments on liquid crystal devices.

Moreover, in the above exemplary embodiment, the halogen lamp heater 31 is used for heating the thermal fluid. However, any heater may be used as long as the heater exhibits an excellent thermal responsiveness and output of the heater can be easily changed.

In the above exemplary embodiment, the inlet-side temperature sensor 61 is in the vicinity of the flow outlet C2 of the vacuum chamber C and between the vacuum chamber C and the flow-rate sensor 32. However, the inlet-side temperature sensor 61 may be provided between the flow-rate sensor 32 and the junction X. In other words, it is only required that the inlet-side temperature sensor 61 is provided between the flow outlet C2 and the junction X.

In the above exemplary embodiment, in S3, it is judged whether the temperature difference T1 is larger than 0.3 degree C. or not. As a threshold of the judgment standard, it is only required that the threshold is in a range where the temperature difference T1 can be decreased only by controlling the output of the halogen lamp heater 31 in S7 to bring the temperature of the thermal fluid close to the target temperature Sᵥ. The threshold is not limited to 0.3 degree C.

In the temperature control method according to the above exemplary embodiment, the temperature controller 1 provided with the pressure control valve 50 is used. However, the temperature control method of the invention is applicable even to a temperature controller without the pressure control valve.

What is claimed is:

1. A temperature controller that circulates and feeds a thermal fluid adjusted to a predetermined target temperature to an object to be temperature-controlled and controls a temperature of the object by means of the circulated and fed thermal fluid, the temperature controller comprising:
a closed first circulation circuit having a fluid cooler;
a closed second circulation circuit having a fluid heater and feeding the thermal fluid heated by the fluid heater to the object;
a feed path that feeds the thermal fluid from the first circulation circuit to the second circulation circuit; and
a discharge path that discharges the thermal fluid from the second circulation circuit and returns the thermal fluid to the first circulation circuit, wherein
a flow-rate control valve that adjusts and controls a feed flow-rate of the thermal fluid from the first circulation circuit is provided in the feed path, and
a pressure control valve that compensates a pressure of the thermal fluid in the second circulation circuit at a predetermined pressure level or less is provided in the discharge path.

2. The temperature controller according to claim 1, wherein
a temperature sensor that detects a temperature of the thermal fluid returned from the object is provided in the vicinity of a flow outlet through which the thermal fluid is discharged from the object.

3. A fluid circulator comprising:
a closed circulation circuit having a fluid heater and feeding a thermal fluid heated by the fluid heater to an object to be temperature-controlled;
a feed path that feeds a cooled thermal fluid to the circulation circuit; and
a discharge path that discharges the thermal fluid fed from the circulation circuit, wherein
a flow-rate control valve that adjusts and controls a feed flow-rate of the cooled thermal fluid is provided in the feed path, and
a pressure control valve that compensates a pressure of the thermal fluid in the circulation circuit at a predetermined pressure level or less is provided in the discharge path.

4. The fluid circulator according to claim 3, wherein
a temperature sensor that detects a temperature of the thermal fluid returned from the object is provided in the vicinity of a flow outlet through which the thermal fluid is discharged from the object.

5. A temperature control method using the temperature controller according to claim 1 for controlling a temperature of the object by means of the thermal fluid circulated and fed by the temperature controller, the temperature control method comprising:
detecting a temperature of the thermal fluid returned from the object and calculating a temperature difference between the detected temperature and a target temperature of the thermal fluid fed to the object;
adjusting and controlling a valve opening degree of the flow-rate control valve based on the calculated result;
after adjusting and controlling the valve opening degree of the flow-rate control valve, detecting a temperature of the thermal fluid fed to the object through the fluid heater and calculating a temperature difference between the detected temperature and the target temperature; and
controlling an output of the fluid heater based on the calculated result.
